(19) United States
(12) Patent Application Publication
(10) Pub. No.: US 2026/0329130 A1
(43) Pub. Date: Oct. 22, 2026

(54) VOLUME HOLOGRAPHIC GRATING ASSEMBLY FOR ULTRA-THIN MINI LIGHT EMITTING DIODE BACKLIGHT, BACKLIGHT MODULE AND METHOD THEREFOR

(71) Applicant: Hefei University of Technology, Hefei (CN)

(72) Inventors: Qibin Feng, Hefei (CN); Zechao Shen, Hefei (CN); Guoqiang Lv, Hefei (CN); Zi Wang, Hefei (CN)

(21) Appl. No.: 19/321,391

(22) Filed: Sep. 8, 2025

(30) Foreign Application Priority Data
Apr. 21, 2025 (CN) 202510502647.2

(51) Int. Cl. G02F 1/13357; G02B 5/18; G02B 5/32

(52) U.S. Cl. CPC G02F 1/133605; G02B 5/1857; G02B 5/32; G02F 1/133603; G02F 1/133606

(57) ABSTRACT

A volume holographic grating (VHG) assembly for ultra-thin Mini light emitting diode (MiniLED) backlight includes a reflective VHG array. A backlight module includes a reflective film, a MiniLED light source, a diffusion film and an optical film arranged with the VHG assembly; the reflective film and the diffusion film are arranged in parallel; the optical film is arranged between the reflective film and the diffusion film and is close to the diffusion film; and the MiniLED light source is arranged close to the reflective film and is directly facing the optical film. In the present disclosure, an optical path can be increased, and the problem that the prior art cannot meet the uniformity requirement under the ultra-thin backlight module.

### CROSS-REFERENCE TO RELATED APPLICATION

This application claims priority of Chinese Patent Application No. 202510502647.2, filed on Apr. 21, 2025, the entire contents of which are incorporated herein by reference.

### TECHNICAL FIELD

The present disclosure relates to the technical field of liquid crystal display, and in particular to a volume holographic grating (VHG) assembly for ultra-thin Mini light emitting diode (MiniLED) backlight, a backlight module and a method therefor.

### BACKGROUND

After years of development, liquid crystal display has become the mainstream technology of flat panel display. Since the liquid crystal does not emit light, a backlight is required to provide illumination light. The brightness, chromaticity, and volume of the backlight module largely determine the performance of the final display. Thinning display products has become a popular trend, which requires backlight modules to minimize the thickness. However, when the thickness requirement of the backlight module is reduced to less than 3 mm, because the optical path is too short, the existing solutions including diffusion films and catadioptric lenses cannot fully open the light, and it is impossible to form a surface light source with uniform brightness at a small distance.

It can be seen that the level of the related art has shown shortcomings in ultra-thin MiniLEDs, and cannot meet the high requirements of the current and future field for ultra-thinning and miniaturization of liquid crystal displays. How to improve the opening degree of light under the condition of ultra-thinning and miniaturization to form a surface light source with uniform brightness has become a key point.

### SUMMARY

An objective of the present disclosure is to solve one of the above technical problems in the related art at least to a certain extent.

Therefore, an objective of the present disclosure is to provide a VHG assembly for ultra-thin MiniLED backlight, a backlight module and a method therefor, which can reflect the light emitted by the MiniLED back to a lamp panel of the backlight module to the greatest extent through the VHG, and reflect the light upward through a reflective film on a surface of the lamp panel, thereby increasing an optical path and solving the problem that the existing technical means cannot meet the requirements of ultra-thin uniformity of the backlight module.

In order to solve the above technical problems, the present disclosure is implemented as follows.

An example of the present disclosure provides a VHG assembly for ultra-thin MiniLED backlight, including a reflective VHG array. A thickness of a single grating unit is 5 μm-15 μm, and the reflective VHG array is a three-dimensional refractive index modulation structure with Bragg diffraction characteristics formed by interference recording of two beams of coherent light.

In addition, the VHG assembly for ultra-thin MiniLED backlight according to the present disclosure also has the following additional technical features.

In some embodiments, a value range of a first exposure distance of the reflective VHG array is 1 mm-2 mm, and a value range of a second exposure distance is 0 mm-2 mm;
the first exposure distance is a distance between a first beam of coherent light point source and the prepared VHG array material; and
the second exposure distance is a distance between a second beam of coherent light point source and the prepared VHG array material.

In some embodiments, a grating radius of the reflective VHG array is determined by a divergence angle of light source and an exposure area, and a value range is 0.5 mm-2 mm.

The example of the present disclosure further provides an ultra-thin MiniLED backlight module, including a reflective film, a MiniLED light source, a diffusion film, and an optical film arranged with the VHG assembly for ultra-thin MiniLED backlight as described in any one of the above;
the reflective film and the diffusion film are arranged in parallel;
the optical film is arranged between the reflective film and the diffusion film and is close to the diffusion film; and
the MiniLED light source is arranged close to the reflective film and is directly facing the optical film.

In addition, the ultra-thin MiniLED backlight module according to the present disclosure also has the following additional technical features.

In some embodiments, a distance between the diffusion film and the optical film is less than 1 mm; and
a distance between the optical film and the reflective film is greater than 0.5 mm.

In some embodiments, the distance between the diffusion film and the optical film is 0 mm; and
the distance between the optical film and the reflective film is 2 mm.

In some embodiments, a first exposure distance of the optical film is 1.5 mm-2 mm, a second exposure distance is 0.75 mm-1.2 mm, and an exposure radius is 0.75-2 mm;
the first exposure distance is a direct distance between the first beam of coherent light point source and the prepared VHG array material; and
the second exposure distance is a distance between the second beam of coherent light point source and the prepared VHG array material.

In some embodiments, the first exposure distance of the optical film is 2 mm, the second exposure distance is 0.9 mm, and the exposure radius is 2 mm.

In some embodiments, the reflective film is a diffuse reflective plate.

The example of the present disclosure also provides a method for preparing the VHG assembly for ultra-thin MiniLED backlight as described in any one of the above, including the steps of:
S1, determining various parameters of the VHG assembly;
the parameters including a first exposure distance, a second exposure distance and an exposure radius of the single grating, a luminous characteristic and a luminous angle of the MiniLED light source, a refractive index and an air refractive index of a VHG material, a maximum divergence angle, a luminous angle, a light intensity of each discrete luminous angle after the light enters the grating material, and a diffraction angle of the light at the exposure distance and a uniformity of a light spot formed by diffraction; and
selecting a structure with the best uniform diffraction effect to determine final parameter values of the VHG assembly; and
S2, preparing the VHG assembly:
building an exposure optical path for preparing the VHG assembly, and adjusting a focal length and a position of a convex lens in the exposure optical path according to the exposure distance and exposure radius set in S1; obtain a three-dimensional grating structure by interference superposition of two beams of coherent light in a photosensitive medium; and perform mass production by nano-imprinting and roll-to-roll process.

Compared with the related art, the present disclosure has at least the following beneficial effects.

In the examples of the present disclosure, the VHG for ultra-thin MiniLED backlight provided can make the light source diffuse for a larger distance at a shorter distance to achieve the effect of uniform light; on the one hand, the light is diffused and diffracted in the opposite direction after passing through the VHG to increase the diffusion angle; on the other hand, the light is reflected upward at the reflecting surface to increase the optical path of the light; and in addition, the diffusion film above the optical film receives the light and further diffuses the light, thereby improving the diffusion effect and the uniformity effect of the light.

Additional solutions and advantages of the present disclosure will be set forth in part in the description which follows, and in part will be obvious from the description which follows, or may be learned by practice of the present disclosure.

### BRIEF DESCRIPTION OF THE DRAWINGS

FIG. 1 is a schematic diagram of an optical module with two layers of diffusion films for existing backlight modules provided in the present disclosure;

FIG. 2 is a light path diagram of a MiniLED backlight module using a VHG provided in an example of the present disclosure;

FIG. 3 is a schematic diagram of a fabrication optical path structure used in preparing the VHG provided in an example of the present disclosure;

FIG. 4 is a simulation illuminance diagram when a VHG optical film is used as a backlight module provided in an example of the present disclosure;

FIG. 5 is a ray trace diagram provided in an example of the present disclosure; and

FIG. 6 is a simulation illuminance diagram when only a diffusion film is used as the backlight module provided in an example of the present disclosure.

Reference numerals and denotations thereof:
101—first reflective film; 102—first MiniLED light source; 103—first diffusion film; and 104—second diffusion film; and
201—second reflective film; 202—second MiniLED light source; 203—optical film; and 204—third diffusion film.

### DETAILED DESCRIPTION

Technical solutions in the examples of the present disclosure will be described clearly and completely in the following with reference to the attached drawings in the examples of the present disclosure. Obviously, all the described examples are only some, rather than all examples of the present disclosure. Based on the examples in the present disclosure, all other examples obtained by those ordinary skilled in the art without creative efforts belong to the protection scope of the present disclosure.

The examples of the present disclosure will be described in detail below through specific examples and application scenarios with reference to the accompanying drawings.

In some examples of the present disclosure, a VHG assembly for ultra-thin MiniLED backlight is provided, the VHG is arranged above a MiniLED chip, the incident light diffracts in the opposite direction around, the light reflected by the VHG reaches a light panel at a bottom of a MiniLED backlight module, and is reflected upward by a surface of the lamp panel at the bottom of the backlight module coated with white paint, reaching a diffusion film above the volume holographic spot, and forming a surface light source with uniform brightness above the diffusion film after passing through the diffusion film.

In some examples of the present disclosure, the VHG forms an array to form an optical film. The MiniLED backlight module includes the diffusion film, the optical film, a reflection film, and a MiniLED light source. The diffusion film is arranged at an upper end of the optical film; the reflective film is arranged at a lower end of the optical film; and the MiniLED light source is arranged between the reflective film and the optical film. The optical film is prepared by the principle of interference recording. MiniLED acts as a light source to emit light around; the optical film receives the light emitted by the light source and changes its direction, part of the light keeps the original optical path unchanged and part of the light changes its direction, and the change direction of the light is related to the preparation parameters of the optical film; the diffracted light changes direction again after passing through the reflective film; and the reflected light is further diffused after passing through the diffusion film together with the previously transmitted light, and finally the diffused light meets the requirement of uniform backlight.

In some examples of the present disclosure, the optical film is a pure-phase element, whose function is to adjust the angle of the light emitted by the MiniLED light source, the optical film diffracts the light that meets the diffraction angle, and the part with higher light intensity in the center of the light source is diffracted to surroundings.

In some examples of the present disclosure, the optical film is simulated and optimized for solution by the Zemax least squares method.

In some examples of the present disclosure, the optical film is recorded by laser interference and can be mass produced by nano-imprinting and roll-to-roll processes.

In the above examples, the reflective film can be replaced with a diffuse reflective plate to further enhance the diffusion effect. The reflective film also directly uses white paint to form a low-cost diffuse reflection area.

The design process of the VHG includes the following steps.

1, a diffusion angle of the light source is calculated. a radius of the light is recorded when the light is at an output end of the backlight module without the diffusion film; and the diffusion angle of the light source can be calculated by formula

$$θ = arctan ( \frac{x}{d} )$$

according to a distance between the light source and the output end.

2, optical parameters for preparing the VHG are calculated. The preparation of VHG depends on the interference of two beams of coherent light. The two beams of light are superimposed in a medium to form a three-dimensional interference fringe pattern with alternating light and dark phases; photosensitive medium (including photopolymer, photorefractive crystal, etc.) undergo physical or chemical changes under the exposure of an interference region, resulting in periodic modulation of a refractive index inside the medium (i.e. three-dimensional grating structure). The grating structure can reproduce the phase of the other one beam of coherent light by diffraction after receiving one beam of coherent light. Main parameters of the two beams of coherent light are light divergence angle, light angle and light source position. The three parameters of the light divergence angle, the light angle and the light source position can be converted by establishing a coordinate system. An xyz three-dimensional rectangular coordinate system is established with a center of the grating as a coordinate origin. The light source position can be represented by xyz coordinates. The light angle is an angle connecting coordinates of the light source and the coordinate origin. The divergence angle of the light can be represented by the position of the light together with the exposed area.

In some examples of the present disclosure, the optical film is included by a VHG array, the Bragg diffraction center wavelength of the VHG is λ, and the parameters of the VHG array are required to be three-dimensional coordinates xyz and a radius r of a single VHG.

In some examples of the present disclosure, the VHG is formed by exposing two opposite beams of diffused light, and the three-dimensional coordinates xy of the exposure light source are both 0. The VHG is formed by exposing two beams of coherent light diverging from the MiniLED light source, and the received light is diffracted into divergent light after passing through the optical film.

In the above examples, an exposure distance z₁ of a first exposure beam is 1 mm-2 mm, and to ensure that the light emitted by the MiniLED satisfies the Bragg diffraction condition between the VHG, the exposure distance z₁ is 1 mm-2 mm. An exposure distance z₂ of a second exposure beam is 0 mm-2 mm, the exposure area is determined by the divergence angle of the MiniLED light source itself and the exposure area at a detector position, and a radius of the VHG is calculated by scaling the isosceles triangle in equal proportion. The VHG is a reflective VHG with a thickness of 5 μm-15 μm.

In some examples of the present disclosure, the VHG can be a monochromatic VHG, a multiplexed VHG, and a multi-layer laminated structure VHG.

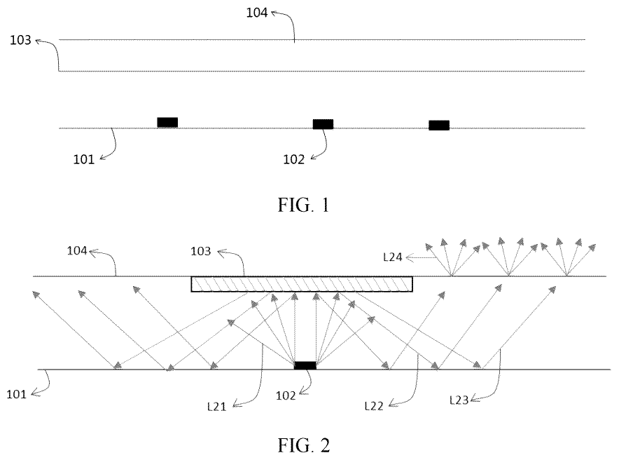

As shown in FIG. 1, the existing backlight module uses a two-layer diffusion film method. The backlight module includes a reflective film 101, a MiniLED light source 102, a first diffusion film 103, and a second diffusion film 104. When the diffusion film on the market is directly placed on the MiniLED or the distance is very close, it has no diffusion effect. Therefore, the technical solution of using the existing diffusion film will cause a very large light mixing distance.

Referring to FIG. 2, in some examples of the present disclosure, the MiniLED backlight module includes a second reflective film 201, a second MiniLED light source 202, an optical film 203, and a third diffusion film 204. The MiniLED light source emits divergent light L21 outwardly; the divergent light L21 enters the optical film 203 at a certain angle and becomes divergent light L22 in the opposite direction after Bragg diffraction with the VHG; the divergent light L22 is totally reflected in contact with the second reflective film 201 and becomes reflected light L23 (similarly, scattered light L23 is formed when a diffuse reflective panel is used); since the VHG on the optical film 203 only exists at a certain position above the light source, most of the reflected light L23 continues to propagate through the optical film 203, and the other part of the light will almost completely transmit through the optical film 203 because the incident angle does not meet the Bragg diffraction condition when contacting the VHG area on the optical film 203; and the reflected light L23 will pass through the optical film to the third diffusion film 204, and the light passes through the third diffusion film 204 to form diffused light L24, which finally satisfies the uniformity condition required by the backlight module.

In the above examples, the optical film 203 is an array of several VHGs, and the preparation of the VHGs depends on the interference of two beams of coherent light. The two beams of light are superimposed in the medium to form a three-dimensional interference fringe pattern with alternating light and dark phases, and the grating exposure parameters include a first exposure distance z₁ and a second exposure distance z₂ of the MiniLED light source with two beams of coherent light from the grating material, as well as a spot size formed by the MiniLED light source at the material position, that is, an exposure radius r. The first exposure distance is a direct distance between the first beam of coherent light point source and the prepared VHG material. The second exposure distance is a direct distance between the second beam of coherent light point source and the prepared VHG material.

In some examples of the present disclosure, the first exposure distance z₁ is 1 mm-2 mm; the second exposure distance z₂ is 0.5-1.5 mm; and the exposure radius is 0.5 mm-2 mm. Further, the first exposure distance is 1.5 mm-2 mm; the second exposure distance is 0.75 mm-1.2 mm; and the exposure radius is 0.75-2 mm. Further preferably, the first exposure distance of the optical film 203 is 2 mm; the second exposure distance is 0.9 mm; and the exposure radius is 2 mm.

In some examples of the present disclosure, a distance between the third diffusion film 204 and the optical film 203 is the first distance, and the first distance is greater than 0.5 mm. A distance between the optical film 203 and the second reflective film 201 is the second distance, and the second distance is less than 0.5 mm. Further, the first distance is 2 mm; and the second distance is 0 mm.

In some examples of the present disclosure, the optical film 203 is used to diffract the light emitted by the MiniLED chip back to the bottom of the backlight to the greatest extent; and the third diffusion film 204 is used to further diffuse and scatter the reflected light.

In some examples of the present disclosure, a method for preparing an optical film for a MiniLED backlight module is also provided, including the following steps.

In step 1: various parameters of the single VHG are set on the optical film;

In step 1.1, the first exposure distance z₁ of the single VHG is set, and z₁ is between 1 mm and 2 mm.

In step 1.2, the second exposure distance z₂ of the single VHG is set, and z₂ is between 0.5 mm and 1.5 mm.

In step 1.3, the exposure radius of the single VHG is set between 0.75 mm and 2 mm.

In step 1.4, the discrete MiniLED light source Pᵢ corresponding to each VHG is set, i=1, 2, 3, . . . , m, and the luminous characteristics of each MiniLED light source are the same as those of each MiniLED chip.

In step 1.5, the light emission angle range of each MiniLED light source Pᵢ is set to (−αₘₐₓ, αₘₐₓ).

In step 1.6, the refractive index of the VHG material is set to n, and the refractive index of air is n₀.

In step 1.7, after the light emitted by the MiniLED light source Pᵢ enters the optical film, the maximum divergence angle is

$${β}_{max} = arctan ( \frac{{z}_{2}}{sin ( {a}_{max} ) * {z}_{1}} ) ,$$

and the light emission angle range is (−βₘₐₓ, βₘₐₓ).

In step 1.8, 0 to βₘₐₓ is discretized into βₙ,

$${β}_{n} = - {β}_{max} + \frac{2 \times {β}_{max}}{154} \times n , n = 1 , 2 , 3 , … ,$$

155.

In step 1.9, z₁ is discretized into zᵢ,

$${z}_{i} = 1 + \frac{1}{100} \times i , i = 1 , 2 , 3 , … , 100.$$

In step 1.10, z₂ is discretized into zⱼ,

$${z}_{j} = 0.5 + \frac{1}{100} \times j , j = 1 , 2 , 3 , … , 100.$$

In step 1.11, the absorption-free diffraction efficiency of the micro-grating is derived and analyzed through the coupled wave theory, and the actual light intensity of each βₙ is derived, thereby knowing the diffraction angle of the light and the uniformity of the diffraction spot formed at the exposure distance. The structure with the best uniform diffraction effect is selected to determine the structure of the optical film.

In step 2: the surface microstructure of the optical film obtained in step 1 is prepared.

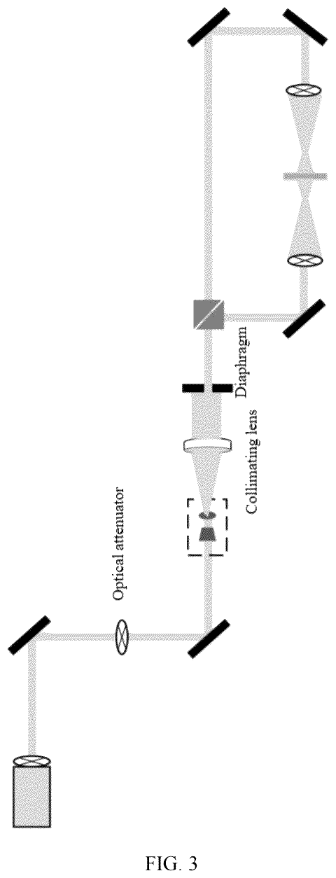

In step 2.1, as shown in FIG. 3, the exposure optical path for preparing the VHG is constructed. The figure shows an exposure optical path for preparing monochromatic VHG. If required, color VHG can also be prepared through grating multiplexing or grating superposition. The first exposure distance z₁, the second exposure distance z₂ and the exposure radius r in step 1 are corresponding by adjusting the focal length and position of convex lens.

In step 2.2, the interference of two beams of coherent light: the two beams of light are superimposed in a medium to form a three-dimensional interference fringe pattern with alternating light and dark phases; and photosensitive medium (including photopolymer, photorefractive crystal, etc.) undergo physical or chemical changes under the exposure of an interference region, resulting in periodic modulation of a refractive index inside the medium (i.e. three-dimensional grating structure). The grating structure can reproduce the phase of the other beam of coherent light by diffraction after receiving one beam of coherent light. A black diaphragm is used to control the optical film to prevent the already exposed VHG structure from being affected when multiple exposures form an array (the array can be constructed by exposing multiple individual pieces separately, which are cut out and bonded together using optical adhesive).

In step 2.3, the mass production can be performed by nano-imprinting and roll-to-roll processes after the structure is confirmed to be reliable.

The nano-imprinting and roll-to-roll processes can be used by existing processes and will not be described in detail.

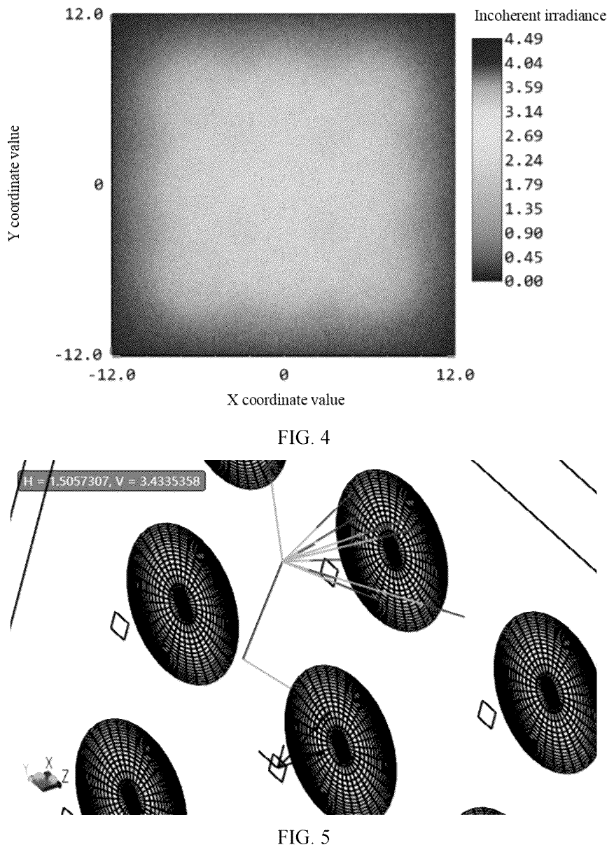

FIG. 4 is a simulation illuminance diagram when a VHG optical film is used as a backlight module provided in an example of the present disclosure. Each MiniLED light source is spaced 6 mm apart from each other. The length and width of the MiniLED are both 0.524 mm. The parameters of the VHG array and the related backlight module are consistent as in step 1 above.

FIG. 5 is a ray trace diagram provided in an example of the present disclosure, and the image shown in the figure is the ray path of the light emitted by the MiniLED light source when the light source angle x is 76°, the light source angle y is 76°, and the light source angle z is 20° in this example.

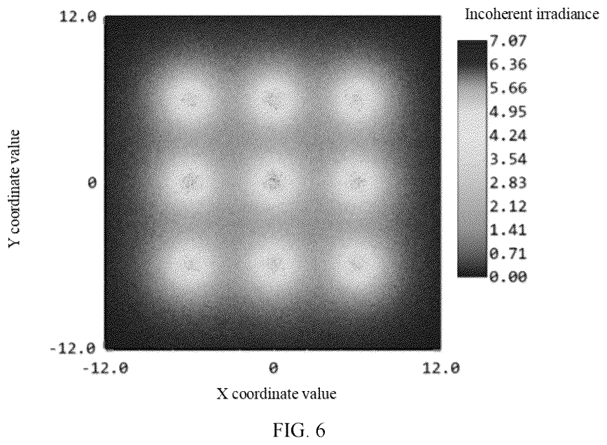

FIG. 6 is a simulation illuminance diagram when the VHG array of the present disclosure is not used, but only the diffusion film is used as the backlight module, and is placed here to compare the effect of the present disclosure.

Parts of the present disclosure that are not described in detail may refer to the related art or are known to those skilled in the art, and the present examples are not limited thereto, and will not be described in detail here.

The examples of the present disclosure have been described above with reference to the accompanying drawings. However, the present disclosure is not limited to the above specific embodiments. The above specific embodiments are merely illustrative and not restrictive. Under the teaching of the present disclosure, those ordinary skilled in the art can also make many forms without departing from the spirit of the present disclosure and the protection scope of the claims, which all belong to the protection of the present disclosure.

1. A volume holographic grating (VHG) assembly for ultra-thin Mini light emitting diode (MiniLED) backlight, comprising a reflective VHG array, wherein a thickness of a single grating unit is 5 μm-15 μm, and the reflective VHG array is a three-dimensional refractive index modulation structure with Bragg diffraction characteristics formed by interference recording of two beams of coherent light.

2. The VHG assembly for ultra-thin MiniLED backlight according to claim 1, wherein a value range of a first exposure distance of the reflective VHG array is 1 mm-2 mm, and a value range of a second exposure distance is 0 mm-2 mm;
the first exposure distance is a distance between a first beam of coherent light point source and the prepared VHG array material; and
the second exposure distance is a distance between a second beam of coherent light point source and the prepared VHG array material.

3. The VHG assembly for ultra-thin MiniLED backlight according to claim 1, wherein a grating radius of the reflective VHG array is determined by a divergence angle of light source and an exposure area, and a value range is 0.5 mm-2 mm.

4. An ultra-thin MiniLED backlight module, comprising a reflective film, a MiniLED light source, a diffusion film, and an optical film arranged with the VHG assembly for the ultra-thin MiniLED backlight according to claim 1, wherein
the reflective film and the diffusion film are arranged in parallel;
the optical film is arranged between the reflective film and the diffusion film and is close to the diffusion film; and
the MiniLED light source is arranged close to the reflective film and is directly facing the optical film.

5. An ultra-thin MiniLED backlight module, comprising a reflective film, a MiniLED light source, a diffusion film, and an optical film arranged with the VHG assembly for the ultra-thin MiniLED backlight according to claim 2, wherein
the reflective film and the diffusion film are arranged in parallel;
the optical film is arranged between the reflective film and the diffusion film and is close to the diffusion film; and
the MiniLED light source is arranged close to the reflective film and is directly facing the optical film.

6. An ultra-thin MiniLED backlight module, comprising a reflective film, a MiniLED light source, a diffusion film, and an optical film arranged with the VHG assembly for the ultra-thin MiniLED backlight according to claim 3, wherein
the reflective film and the diffusion film are arranged in parallel;
the optical film is arranged between the reflective film and the diffusion film and is close to the diffusion film; and
the MiniLED light source is arranged close to the reflective film and is directly facing the optical film.

7. The ultra-thin MiniLED backlight module according to claim 4, wherein a distance between the diffusion film and the optical film is less than 1 mm; and
a distance between the optical film and the reflective film is greater than 0.5 mm.

8. The ultra-thin MiniLED backlight module according to claim 5, wherein a distance between the diffusion film and the optical film is less than 1 mm; and
a distance between the optical film and the reflective film is greater than 0.5 mm.

9. The ultra-thin MiniLED backlight module according to claim 6, wherein a distance between the diffusion film and the optical film is less than 1 mm; and
a distance between the optical film and the reflective film is greater than 0.5 mm.

10. The ultra-thin MiniLED backlight module according to claim 7, wherein the distance between the diffusion film and the optical film is 0 mm; and
the distance between the optical film and the reflective film is 2 mm.

11. The ultra-thin MiniLED backlight module according to claim 8, wherein the distance between the diffusion film and the optical film is 0 mm; and
the distance between the optical film and the reflective film is 2 mm.

12. The ultra-thin MiniLED backlight module according to claim 9, wherein the distance between the diffusion film and the optical film is 0 mm; and
the distance between the optical film and the reflective film is 2 mm.

13. The ultra-thin MiniLED backlight module according to claim 4, wherein a first exposure distance of the optical film is 1.5 mm-2 mm, a second exposure distance is 0.75 mm-1.2 mm, and an exposure radius is 0.75 mm-2 mm;
the first exposure distance is a direct distance between the first beam of coherent light point source and the prepared VHG array material; and
the second exposure distance is a distance between the second beam of coherent light point source and the prepared VHG array material.

14. The ultra-thin MiniLED backlight module according to claim 5, wherein a first exposure distance of the optical film is 1.5 mm-2 mm, a second exposure distance is 0.75 mm-1.2 mm, and an exposure radius is 0.75 mm-2 mm;
the first exposure distance is a direct distance between the first beam of coherent light point source and the prepared VHG array material; and
the second exposure distance is a distance between the second beam of coherent light point source and the prepared VHG array material.

15. The ultra-thin MiniLED backlight module according to claim 6, wherein a first exposure distance of the optical film is 1.5 mm-2 mm, a second exposure distance is 0.75 mm-1.2 mm, and an exposure radius is 0.75 mm-2 mm;
the first exposure distance is a direct distance between the first beam of coherent light point source and the prepared VHG array material; and
the second exposure distance is a distance between the second beam of coherent light point source and the prepared VHG array material.

16. The ultra-thin MiniLED backlight module according to claim 13, wherein the first exposure distance of the optical film is 2 mm, the second exposure distance is 0.9 mm, and the exposure radius is 2 mm.

17. The ultra-thin MiniLED backlight module according to claim 4, wherein the reflective film is a diffuse reflective plate.

18. A method for preparing the VHG assembly for ultra-thin MiniLED backlight according to claim 1, comprising the steps of:
S1, determining various parameters of the VHG assembly;
the parameters comprising a first exposure distance, a second exposure distance and an exposure radius of the single grating, a luminous characteristic and a luminous angle of the MiniLED light source, a refractive index and an air refractive index of a VHG material, a maximum divergence angle, a luminous angle, a light intensity of each discrete luminous angle after the light enters the grating material, and a diffraction angle of the light at the exposure distance and a uniformity of a light spot formed by diffraction; and
selecting a structure with the best uniform diffraction effect to determine final parameter values of the VHG assembly; and
S2, preparing the VHG assembly:
building an exposure optical path for preparing the VHG assembly, and adjusting a focal length and a position of a convex lens in the exposure optical path according to the exposure distance and exposure radius set in S1; obtaining a three-dimensional grating structure by interference superposition of two beams of coherent light in a photosensitive medium; and performing mass production by nano-imprinting and roll-to-roll process.

19. A method for preparing the VHG assembly for ultra-thin MiniLED backlight according to claim 2, comprising the steps of:
S1, determining various parameters of the VHG assembly;
the parameters comprising a first exposure distance, a second exposure distance and an exposure radius of the single grating, a luminous characteristic and a luminous angle of the MiniLED light source, a refractive index and an air refractive index of a VHG material, a maximum divergence angle, a luminous angle, a light intensity of each discrete luminous angle after the light enters the grating material, and a diffraction angle of the light at the exposure distance and a uniformity of a light spot formed by diffraction; and
selecting a structure with the best uniform diffraction effect to determine final parameter values of the VHG assembly; and
S2, preparing the VHG assembly:
building an exposure optical path for preparing the VHG assembly, and adjusting a focal length and a position of a convex lens in the exposure optical path according to the exposure distance and exposure radius set in S1; obtaining a three-dimensional grating structure by interference superposition of two beams of coherent light in a photosensitive medium; and performing mass production by nano-imprinting and roll-to-roll process.

20. A method for preparing the VHG assembly for ultra-thin MiniLED backlight according to claim 3, comprising the steps of:
S1, determining various parameters of the VHG assembly;
the parameters comprising a first exposure distance, a second exposure distance and an exposure radius of the single grating, a luminous characteristic and a luminous angle of the MiniLED light source, a refractive index and an air refractive index of a VHG material, a maximum divergence angle, a luminous angle, a light intensity of each discrete luminous angle after the light enters the grating material, and a diffraction angle of the light at the exposure distance and a uniformity of a light spot formed by diffraction; and
selecting a structure with the best uniform diffraction effect to determine final parameter values of the VHG assembly; and
S2, preparing the VHG assembly:
building an exposure optical path for preparing the VHG assembly, and adjusting a focal length and a position of a convex lens in the exposure optical path according to the exposure distance and exposure radius set in S1; obtaining a three-dimensional grating structure by interference superposition of two beams of coherent light in a photosensitive medium; and performing mass production by nano-imprinting and roll-to-roll process.
